(19) United States
(12) Patent Application Publication
(10) Pub. No.: US 2004/0109606 A1
(43) Pub. Date: Jun. 10, 2004

(54) Image forming apparatus

(75) Inventor: Hiroyuki Okuyama, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/309,102

(22) Filed: Dec. 4, 2002

(51) Int. Cl. G06K 9/00

(52) U.S. Cl. 382/181

(57) ABSTRACT

An image forming apparatus includes a scanner section which generates an image data from a read image of an original document, a character discriminator section which discriminates a part of the image data that represents characters and outputting a character discrimination data, a binary-coder section which binary-codes the image data and outputs a binary-coded image data, and a character code section which generates a character code in accordance with the binary-coded image data and the character discrimination data.

### BACKGROUND OF THE INVENTION

1. Field of the Invention

The present invention relates to an image forming apparatus, and more particularly, to an image forming apparatus provided with a function for reading characters from an image of a color original document.

2. Description of the Related Art

Conventionally known is an image forming apparatus that has a function to read characters from a color image. The apparatus of this type is stored with software that realizes a color optical character reader (OCR) function such that the characters are recognized from the color image. When a user gives an instruction for the execution of the function, the apparatus temporarily stores, as an image file, RGB image data of individual colors, red (R), green (G), and blue (B), read by means of a scanner. Thereafter, the apparatus detects a ground for the data and carries out binary-coding with reference to the data. Further, the apparatus codes a character region that is included in the data by extracting outline data from the binary-coded image data.

Thus, according to the color OCR function that is based on software, the characters are identified after the color image data is binary-coded, as described above, so that high-accuracy discrimination is difficult.

Accordingly, there is a need for an image forming apparatus that can improve the accuracy of characteristic recognition based on the color OCR function by utilizing the multivalued RGB image data that are read by means of the scanner and are not binary-coded yet.

### BRIEF SUMMARY OF THE INVENTION

According to an aspect of the present invention, an image forming apparatus comprises a scanner section which generates an image data from a read image of an original document, a character discriminator section which discriminates a part of the image data that represents characters and outputs a character discrimination data, a binary-coder section which binary-codes the image data and outputs binary-coded image data, and a character code section which generates a character code in accordance with the binary-coded image data and the character discrimination data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic view of an image forming apparatus according to an embodiment of the invention;

FIG. 2 is a block diagram showing a control configuration of a control panel section of the same embodiment;

FIG. 3 is a diagram showing a control block of scanner section of the same embodiment;

FIG. 4 is a diagram showing a control block of a print engine section of the same embodiment;

FIG. 5 is a diagram showing a control block of a basic processor of the same embodiment;

FIG. 6 is a diagram for illustrating an image processing function of the same embodiment;

FIG. 7 is a diagram showing a configuration of a character recognition/coding section of the same embodiment; and

FIG. 8 is a flowchart showing processing of the same embodiment.

### DETAILED DESCRIPTION OF THE INVENTION

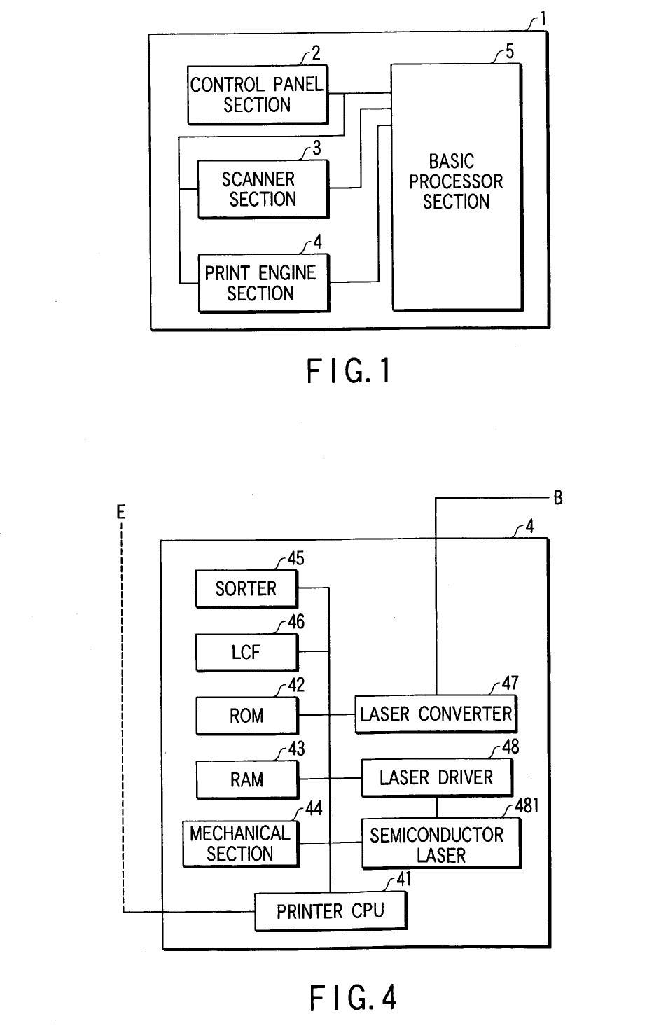

An embodiment of the present invention will now be described with reference to the drawings. The following is a description of the case where the present invention is applied to a multifunction peripheral (MFP) as a color multifunction machine. The MFP 1 shown in FIG. 1 comprises a control panel section 2, scanner section 3, print engine section 4, and basic processor 5.

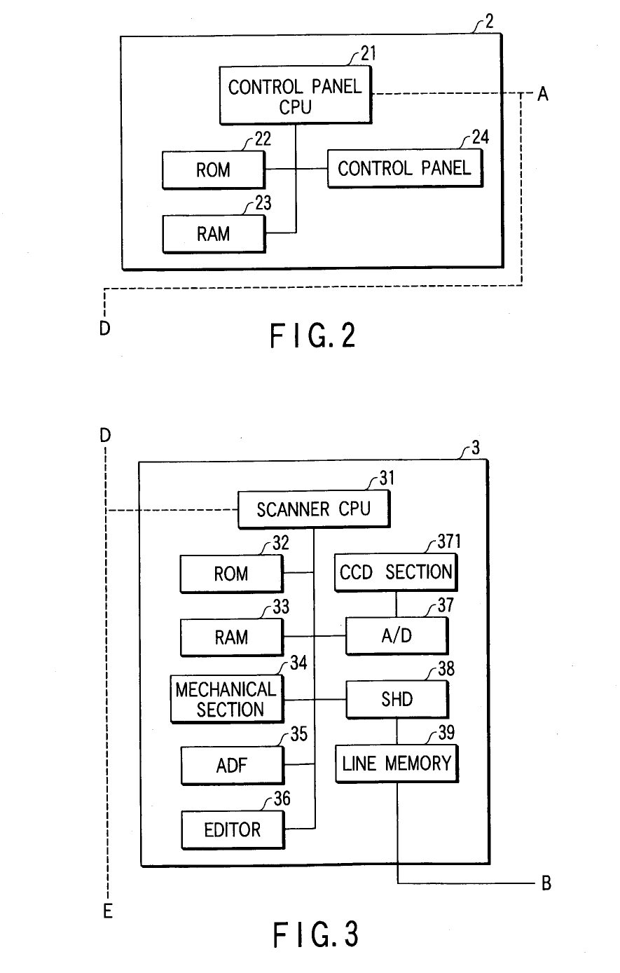

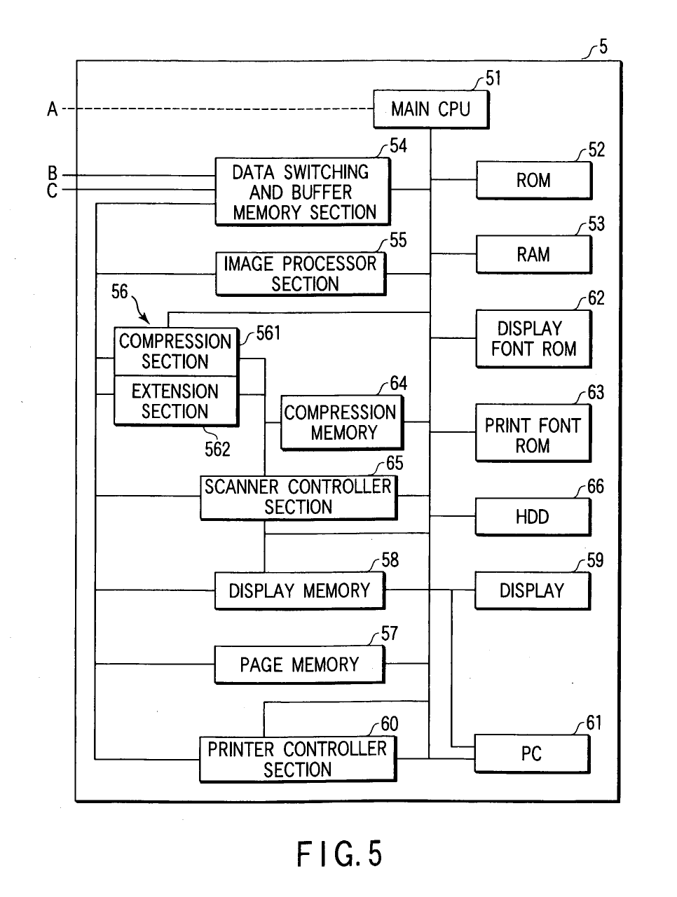

FIGS. 2 to 5 are views showing control blocks of the MFP 1. In the MFP 1, a control panel CPU 21, scanner CPU 31, printer CPU 41, and main CPU 51 controls the control panel section 2, scanner section 3, print engine section 4, and basic processor 5, respectively. Further, the main CPU 51 communicates with the control panel CPU 21, scanner CPU 31, and printer CPU 41 and controls them.

The control panel CPU 21 is connected to a ROM 22 and a RAM 23. Based on data stored in the ROM 22 and the RAM 23, the control panel CPU 21 carries out detection of switches on a control panel 24, on-off operation for LED's, control of indicators, etc.

Based on data stored in a ROM 32 and a RAM 33, the scanner CPU 31 carries out control of a mechanical section 34, including a motor, solenoid, etc. (not shown), and control of an automatic document feeder (ADF) 35, coordinate input unit (editor) 36, analog-to-digital converter (A/D) 37, shading correction circuit (SHD) 38, line memory 29, etc. Further, a CCD section 371 is connected to the A/D 37. The CCD section 371 reads image data of individual colors, red (R), green (G), and blue (B), by means of a color CCD sensor, for example.

Based on data stored in a ROM 42 and a RAM 43, the printer CPU 41 carries out control of a mechanical section 44, including a motor, solenoid, etc. (not shown), and control of a sorter 45, large cassette feeder (LCF) 46, laser converter 47, laser driver 48 for controlling a semiconductor laser 481, etc.

The main CPU 51 comprehensively controls the MFP 1 in accordance with control programs that are stored in a ROM 52 and a RAM 53.

A data switching and buffer memory section 54 effects switching as to where data scanned by scanner section 3 is to be sent, and which data is to be sent to the print engine section 4. An image processor section 55 includes a scanner image processor section 551 and an output image upgrader section 552, and is composed of a circuit. In a compression/extension section 56, a compression section 561 compresses image data, while an extension section 562 extends image data. A page memory 57 can store image data for each page. A display memory 58 is loaded with image data to be displayed on a display 59. A printer controller section 60 develops code data from a personal computer (PC) 61 into image data. A display font ROM 62 develops the code data on the display memory 58. A print font ROM 63 develops the code data on the page memory 57. A compression memory 64 stores data that are compressed by means of the compression section 561 of the compression/extension section 56.

The main CPU 51 is further connected to a drive, e.g., a hard disc drive (HDD) 66, through a scanner controller section 65. The HDD 66 is stored with a various files and the like and a control program for realizing a color OCR function for recognizing characters from image data. The main CPU 51 executes the control program by utilizing a work area that is formed in the RAM 52, for example.

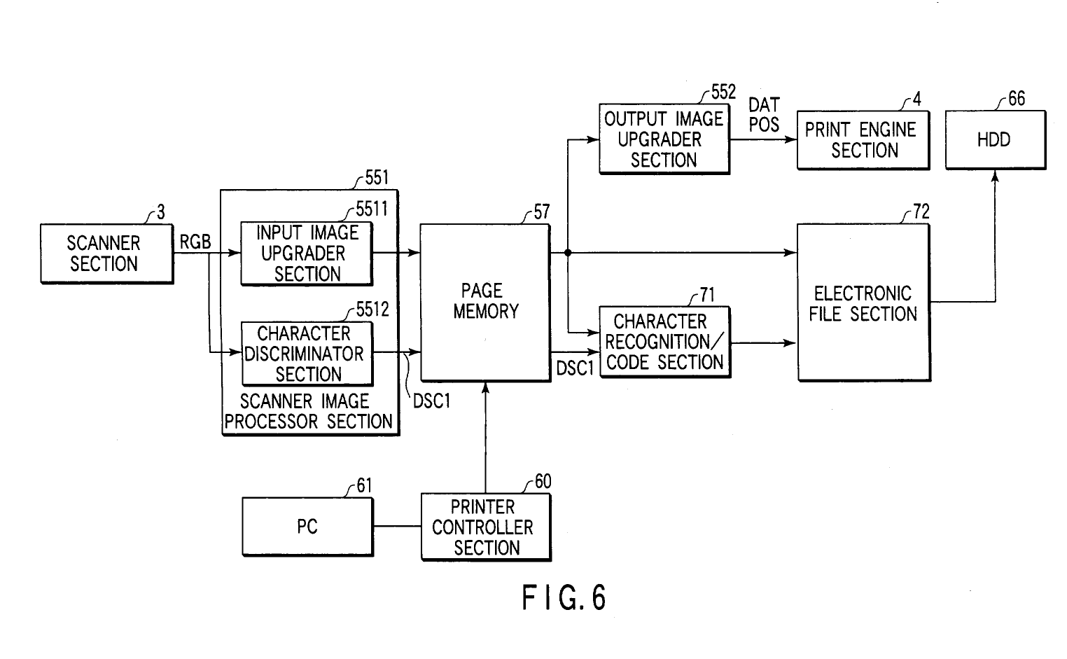

The color OCR function with which the MFP 1 reads the image of a color original document located in a predetermined position (not shown) from the scanner section 3 will be described with reference to FIG. 6.

The scanner image processor section 551 is composed of an input image upgrader section 5511 and a character discriminator section 5512. RGB image data read by means of the scanner section 3 are applied to the input image upgrader section 5511 and the character discriminator section 5512 of the scanner image processor section 551. The input image upgrader section 5511 carries out processing for upgrading the RGB image data, such as color conversion, filtering, etc. The character discriminator section 5512 determines whether or not the RGB image data is character data, and generates first discrimination data (DSC₁) as data that represents the result of this discrimination. According to this discrimination, a processing window with a given size is set for a target pixel, for example, and whether or not the image data is character data is determined by comparing the target pixel and peripheral pixels. These processes are executed by means of circuits or hardware. The RGB image data thus processed by means of the processor section 5511 and the first discrimination data generated by means of the processor section 5512 are individually delivered to the page memory 57 through the compression/extension section 56 (not shown in FIG. 6).

Subsequently, the RGB image data extended by means of the page memory 57 and the compression/extension section 56 (not shown in FIG. 6) is applied to a character recognition/code section 71 and an electronic file section 72. Further, the first discrimination data is applied to the character recognition/code section 71. The character recognition/code section 71 and the electronic file section 72 are obtained as the main CPU 51 executes the control program that is stored in the HDD 66 and serves to realize the OCR function. The processing carried out in the character recognition/code section 71 and the electronic file section 72 is realized by means of software.

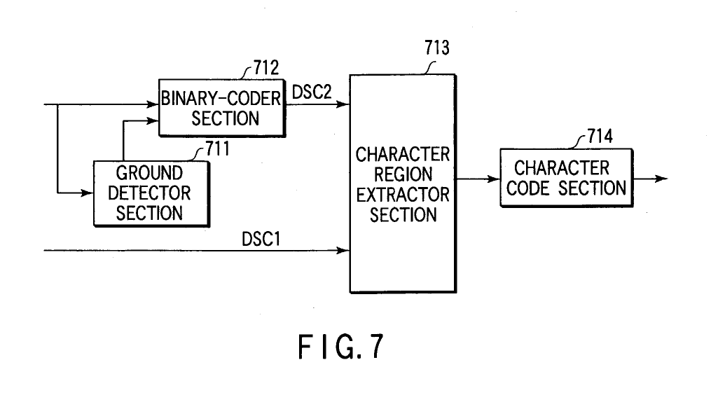

As shown in FIG. 7, the character recognition/code section 71 is composed of a ground detector section 711, binary-coder section 712, character region extractor section 713, and character code section 714.

The RGB image data applied to the character recognition/code section 71 is applied to the ground detector section 711 and the binary-coder section 712. In the ground detector section 711, the ground region is detected from the RGB image data, and a ground detection data as the result of this detection is delivered to the binary-coder section 712. Based on the result of detection of the ground region, the binary-coder section 712 dynamically changes its internal operation to perform binary-coding, thereby generating a second discrimination data (DSC₂). The second discrimination data, obtained by thus binary-coding the RGB image data, is delivered to the character region extractor section 713.

The first and second discrimination data are applied to the input of the character region extractor section 713. Based on the first and second discrimination data, the character region extractor section 713 makes a predetermined decision, thereby finally extracting characters. This predetermined decision is made by obtaining the logical product of the first and second discrimination data, for example. Thus, character data is identified if characters are recognized by both the first and second discrimination data. Further, the character region extractor section 713 extracts a character region by extracting outline data from the region where the character data is identified. The result is delivered to the character code section 714. Thus, the character region is extracted by utilizing character discrimination that uses software based on the binary-coder section 712 and character discrimination that uses hardware based on the character discriminator section 5512, so that the accuracy of character discrimination can be improved.

The character code section 714 converts the character region extracted by means of the character region extractor section 713 into character code data based on, for example, black characters that are previously provided corresponding to the characters. The code data and layout data for the characters are delivered to the electronic file section 72.

The electronic file section 72 originates photograph region data from the input RGB image data, combines the photograph region data with the character code data and the character layout data inputted from the character recognition/code section 71, and converts the resultant data into a file. This file is stored in, for example, the HDD 66 under the control of the main CPU 51. The file stored in the HDD 66 has an interface through which the MFP 1 is connected to a network, for example. If the file is connected to a PC or the like through the interface, it can be incorporated into the PC. Alternatively, the file may be incorporated directly into the PC that is connected to the network.

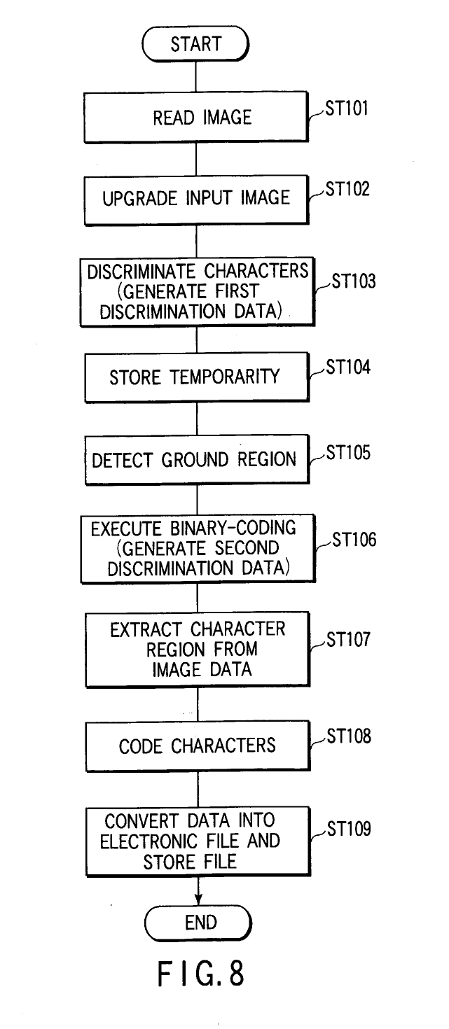

An example of processing for reading the image data from the color original document by means of the color OCR function will now be described with reference to the flowchart of FIG. 8.

In Step ST101, the scanner section 3 reads an image of the color original document located in the predetermined position (not shown) in response to an instruction from the control panel 24, and delivers it as RGB image data to the scanner image processor section 551.

In Step ST102, the input image upgrader section 5511 subjects the RGB image data to the aforesaid image upgrading. In Step ST103, the character discriminator section 5512 discriminates characters from the multivalued RGB image data and generates the first discrimination data.

In Step ST104, the upgraded RGB image data and the first discrimination data are compressed by means of the compression/extension section 56 and temporarily stored in the page memory 57. When each of the stored data is outputted from the page memory 57, it is extended by means of the compression/extension section 57.

The processes of Steps ST101 to ST104 are processes that use the scanner section 3, scanner image processor section 551, etc. as hardware. Thus, the first discrimination data is generated by means of hardware.

Subsequently, the main CPU 51 carries out the following processing in accordance with the control program that realizes the color OCR function stored in the HDD 66.

In Step ST105, the main CPU 51 detects the ground region from the extended RGB image data from the page memory 57. In Step ST106, the main CPU 51 subjects the RGB image data to binary-coding with reference to the detected ground region, thereby generating the second discrimination data.

In Step ST107, the main CPU 51 determines whether or not the RGB image data is character data in accordance with the first and second discrimination data. Further, the character region is extracted from the data by extracting the outline data from the region where the character data is identified. The character data is identified if both the first and second discrimination data represent characters, for example.

In Step ST108, the main CPU 51 makes the extracted character region correspond to character code data that is provided in advance so as to correspond to the character region. Further, the code data is made to correspond to the character layout data.

In Step ST109, the main CPU 51 synthesizes the photograph region data by the use of the upgraded RGB image data, the code data, and layout data into an electronic file, and stores it in a predetermined region of the HDD 66, for example.

The processes of Steps ST105 to ST109 are processes the main CPU 51 executes by the use of software. Thus, the second image data is formed by means of software.

Further, the MFP 1 constructed in this manner has a copying function and a printer function, as well as the scanner function described above.

According to the copying function, the RGB image data read by means of the scanner section 3 is processed in the scanner image processor section 511 and applied to the input of the output upgrader section 552 through the compression/extension section 56 and the page memory 57. In the output upgrader section 552, gradation processing and the like are carried out, and image data (DAT) and reference position data (POS) are delivered to the print engine section 4. The print engine section 4 forms an image in accordance with the inputted data.

According to the printer function, image data transmitted from the PC 61 or externally from the network are applied to the input of the output upgrader section 552 through the compression/extension section 56 and the page memory 57. In the output upgrader section 552, the image data are subjected to image processing such as smoothing. The image data and the reference position data are delivered to the print engine section 4. The print engine section 4 forms an image in accordance with those data.

Thus, in order to detect the character region that is included in the RGB image data read from the scanner section 3, the MFP 1 identifies the character region by the use of the multivalued RGB image data and also identifies the character region by the use of the binary-coded RGB image data. The character region that is contained by the color original document can be detected with high accuracy by finally extracting the character region with use of the two discrimination data.

Since the first discrimination data that is utilized for the final identification of the characters is generated by means of hardware that reads images, image data obtained from hardware can be used effectively.

Further, the MFP 1 can highly accurately detect the characters from the image of the color original document. Therefore, it can process the image of the character part as the characters when the image is formed in accordance with the file stored in the HDD 66 or when the image is formed in accordance with the file incorporated in the PC through the network, for example. Thus, the image of the character region can be formed with high quality.

This embodiment has been described with respect to the MFP that reads the characters from the color original document by means of the color CCD sensor. However, the configuration in which the character region is identified with use of the multivalued RGB image data and the character region of the original document is identified with use binary-coded RGB image data may be also applied to an MFP that is mounted with a monochromatic CCD sensor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a scanner section which generates an image data from a read image of an original document;
a character discriminator section which discriminates a part of the image data that represents characters and outputs a character discrimination data;
a binary-coder section which binary-codes the image data and outputs a binary-coded image data; and
a character code section which generates a character code in accordance with the binary-coded image data and the character discrimination data.

2. The image forming apparatus according to claim 1, further comprising a ground region detector section which detects a ground region from the image data and outputs a ground region data, wherein the binary-coder section changes the binary-coding operation for the image data in accordance with the ground region data.

3. The image forming apparatus according to claim 1, further comprising an image upgrader section which upgrades the image data and delivers the upgraded image data to the binary-coder section.

4. The image forming apparatus according to claim 1, further comprising a storage section for storing the image data and the character discrimination data, wherein the binary-coder section is supplied with the image data stored in the storage section, and the character code section is supplied with the character discrimination data stored in the storage section.

5. A method for discriminating characters when an image forming apparatus reads an image, comprising:
generating an image data from an image read from an original document;
discriminating a part of the image data that represents characters and outputting a character discrimination data;
binary-coding the image data and outputting a binary-coded image data; and
generating a character code in accordance with the binary-coded image data and the character discrimination data.

6. The method according to claim 5, further comprising detecting a ground region from the image data and outputting a ground region data, wherein the image data binary-coding process includes changing the binary-coding operation for the image data in accordance with the ground region data.

7. The method according to claim 5, further comprising upgrading the image data and outputting the upgraded image data.

8. The method according to claim 5, further comprising storing the image data and the character discrimination data, outputting the stored image data in order to carry out binary-coding, and outputting the stored character discrimination data in order to generate the character code.
